(19) United States
(12) Patent Application Publication
(10) Pub. No.: US 2005/0231162 A1
(43) Pub. Date: Oct. 20, 2005

(54) Mobile work robot

(75) Inventor: Hiroyuki Takenaka, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Osaka (JP)

(21) Appl. No.: 11/105,871

(22) Filed: Apr. 14, 2005

(30) Foreign Application Priority Data
Apr. 16, 2004 (JP) JP2004-121660

(51) Int. Cl. H02J 7/00

(52) U.S. Cl. 320/114

(57) ABSTRACT

A mobile work robot includes a running unit for movement, a working unit, a control unit controlling various portions of the mobile work robot with a provided instruction signal, an operation switch unit externally operated to provide the instruction signal for controlling an operation of the mobile work robot to the control unit; and a main battery supplying an electric power to the various portions of the mobile work robot. The control unit does not accept the provided instruction signal during the charging state when it is detected from a signal of a power supply connector that an AC adapter of the main battery is connected to achieve the charging state.

### BACKGROUND OF THE INVENTION

1. Field of the Invention

The present invention relates to a mobile work robot, and particularly to a mobile work robot having a function of preventing a malfunction (misoperation) during a charging operation.

2. Description of the Background Art

There has been a mobile work robot, which is provided by adding a self-propelled function to a work device for cleaning or floor washing, and employs a rechargeable battery as its power supply for automating operations.

Japanese Patent Laying-Open No. 08-252203 has disclosed a technique relating to charging of a battery arranged in a mobile work robot. Japanese Patent Laying-Open No. 2001-079792 has proposed a structure of an electrode for charging. Japanese Patent Laying-Open No. 2002-244731 has disclosed a technique for externally notifying of a state during charging.

Since the mobile work robot having such charging function has a console panel, which is exposed externally, a user may carelessly touch the console panel to cause a malfunction during charging. For preventing such malfunction, Japanese Patent Laying-Open No. 07-171074 has disclosed a technique, in which a cover member covers a console panel unit during charging for preventing an operation.

In the technique configured to cover the console panel as described above for preventing a careless operation during charging, provision of the cover member increases the number of parts of the mobile work robot, and impedes reduction in size.

### SUMMARY OF THE INVENTION

An object of the invention is to provide a mobile work robot, which can prevent a malfunction during charging, without increasing the number of parts.

For achieving the above object, a mobile work robot according to an aspect of the invention includes a running unit for movement; a working unit; a control unit controlling various portions of the mobile work robot with a provided instruction signal; an operation unit externally operated to provide the instruction signal for controlling an operation of the mobile work robot to the control unit; and a battery supplying an electric power to the various portions of the mobile work robot. The control unit does not accept the provided instruction signal while the battery is in a charging state.

Accordingly, even if the operation unit is carelessly operated during a period of the charging state, the control unit does not accept the instruction signal applied by such careless operation so that the control unit does not control the operation of the mobile work robot. Therefore, a malfunction during the charging can be prevented without requiring a cover member or the like covering the operation unit for avoiding the careless operation.

Preferably, the control unit has a state determining unit determining whether the battery is in the charging state or not. Therefore, the state determining unit can determine whether the battery is in the charging state or not, without receiving a particular instruction from a user.

Preferably, the mobile work robot further includes a charge detecting unit detecting a connection of the battery to a charging unit prepared in advance, and providing a detection signal indicating a result of the detection. The state determining unit determines whether the charging state is currently achieved or not, based on the detection signal provided from the charge detecting unit. Therefore, it is possible to determine whether the charging state is currently achieved or not, by detecting or not detecting the connection of the charging unit.

Preferably, the state determining unit determines whether the battery is in the charging state or not, based on a remaining amount of power of the battery.

Preferably, the mobile work robot provides a notification of the charging state. Based on the notification, the user can easily confirm the charging state of the battery.

According to another aspect of the invention, a mobile work robot according to an aspect of the invention includes a running unit for movement; a working unit; a control unit controlling various portions of the mobile work robot with a provided instruction signal; an operation unit externally operated to provide the instruction signal for controlling an operation of the mobile work robot to the control unit; and a battery supplying an electric power to the various portions of the mobile work robot. The control unit does not accept the provided instruction signal while the battery is in the charging state. The control unit has a state determining unit determining whether the battery is in the charging state or not. The mobile work robot further includes a charge detecting unit detecting a connection of the battery to a charging unit prepared in advance, and providing a detection signal indicating a result of the detection. The state determining unit determines whether the charging state is currently achieved or not, based on the detection signal provided from the charge detecting unit, or based on a remaining amount of a power of the battery. The mobile work robot further has a function of providing a notification that the battery is in the charging state.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a block structure of a mobile work robot according to an embodiment of the invention.

FIG. 2 is a top view showing an outer appearance of the mobile work robot according to the embodiment of the invention.

FIGS. 3, 4 and 5 are flowcharts illustrating processing procedures for preventing a careless operation during charging according to the embodiment of the invention.

### DESCRIPTION OF THE PREFERRED EMBODIMENTS

A robot, which automatically performs a cleaning operation, will now be discussed as an example of a mobile work robot, although the invention is not restricted to such a robot.

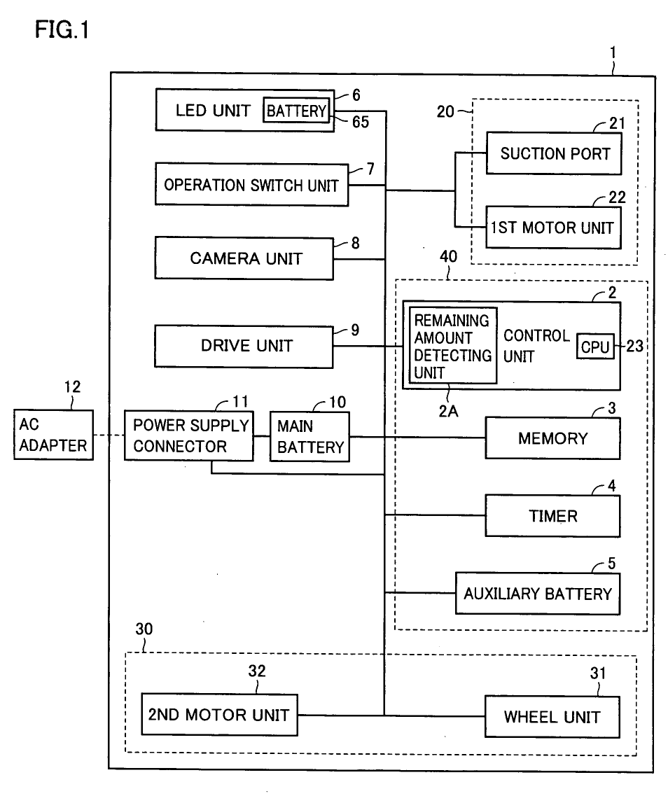

FIG. 1 shows a structure of a mobile work robot according to an embodiment of the invention. Referring to FIG. 1, a mobile work robot 1 includes an LED (Light Emitting Diode) unit 6 for notifying of operation states and others by light, an operation switch unit 7 operated by a user for entering various instructions to control the operation of mobile work robot 1, a camera unit 8 for a security function, a drive unit 9 for driving mobile work robot 1, a main battery 10, which is a rechargeable battery provided for supplying a power for operations to various portions, a power supply connector 11, which is removably connected to an external AC (Alternating Current) adapter 12, a cleaning unit 20 functioning as a work unit, a running unit 30 for movement and a processing unit 40.

Cleaning unit 20 has a suction port 21 for taking in dust or the like on a floor, and a first motor unit 22 generating a vacuum for taking in the dust through suction port 21.

Running unit 30 has a wheel unit 31 having a plurality of wheels rotating for movement, and a second motor unit 32 for rotating the wheels in wheel unit 31.

Processing unit 40 has a control unit 2 including a CPU (Central Processing Unit) 23 for controlling and monitoring mobile work robot 1 itself and a remaining amount detecting unit 2A, a memory 3 for storing various data and programs, a timer 4 for timing and an auxiliary battery 5. Control unit 2 controls various portions of mobile work robot 1 based on various instruction signals provided from operation switch unit 7, and thereby controls the operation of mobile work robot 1.

Main battery 10 supplies an electric power to various portions in mobile work robot 1. In a charging operation, main battery 10 is charged by an electric power supplied from an external commercial power supply (not show) or the like via AC adapter 12 connected to power supply connector 11. In the charging operation, various portions in processing unit 40 are powered for operation by auxiliary battery 5 instead of main battery 10. Auxiliary battery 5 is a small battery such as a button battery. When main battery 10 is being charged, LED unit 6 is powered for operation by an internal auxiliary battery 65 instead of main battery 10. Battery 65 is likewise a small battery such as a button battery.

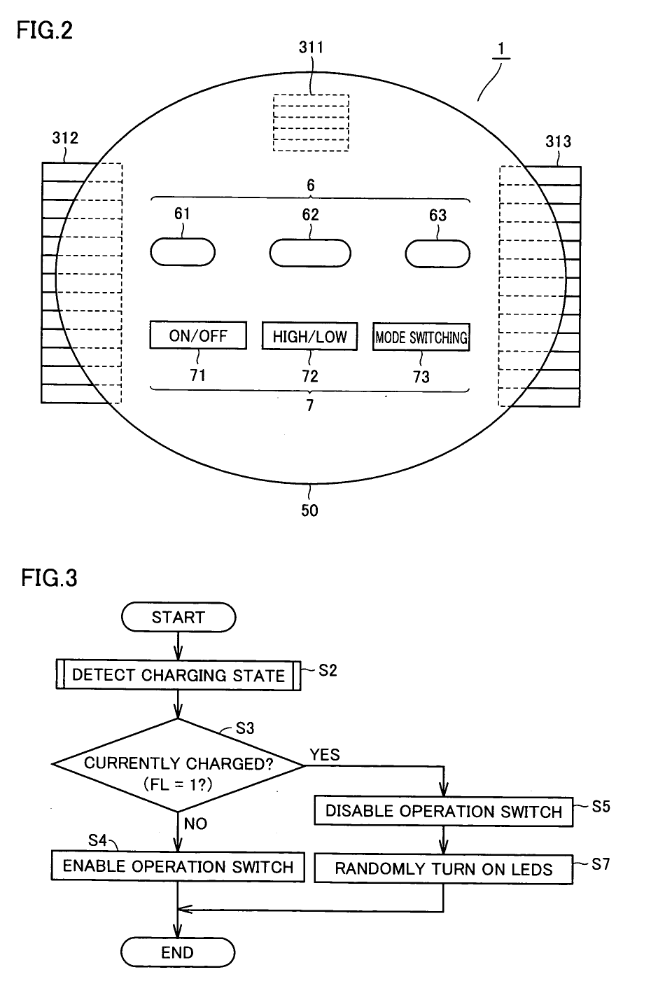

FIG. 2 is a top view showing an appearance of mobile work robot 1. Referring to FIG. 2, mobile work robot 1 has a casing 50 covering a main body. On the top surface of casing 50, mobile work robot 1 has a plurality of LED lamps 61-63 of LED unit 6 allowing easy visual recognition by a user, and also has user-operable switches of operation switch unit 7, i.e., a switch 71 for turning on/off the power to start or stop a cleaning operation, a switch 72 for switching the suction power between high and low, and a switch 73 for switching an operation mode. The kinds of switches to be operated are not restricted to the above. Wheel unit 31 includes three wheels 311, 312 and 313.

An operation during the charging of main battery 10 will now be described with reference to flowcharts of FIGS. 3 to 5. Procedures in FIGS. 3 to 5 as programs is prestored in memory 3. CPU 23 in control unit 2 reads the programs from memory 3, and periodically repeats execution of the programs thus read.

Referring to FIG. 3, in step S2, procedure for detecting the changing state is executed. Thereafter, control unit 2 determines whether main battery 10 is in the charging state or not (step S3). This determination is performed based on a value of a flag FL, which is a temporary variable indicating whether battery 10 is in the charging state or not (i.e., is being charged or not). Flag FL is stored in an internal memory of CPU 23.

When it is in the charging state, a power supply to various portions from main battery 10 is cut off. During a charging period, control unit 2 performs the control to use auxiliary battery 5 for supplying the power instead of main battery 10. Control unit 2 also performs the control to energize LED unit 6 by battery 65 instead of main battery 10.

When control unit 2 determines that main battery 10 is being charged (YES in step S3), control unit 2 disables operation switch unit 7, which may be operated for instructing execution of the operations such as running of mobile work robot 1 (step S5). Thus, the user can operate, e.g., by touching or depressing, any switch of operation switch unit 7, control unit 2 does not accept the instruction signal provided from operation switch unit 7 based on contents of such user's operation, and thus disables the switch operation. In the states other than the charging (NO in step S3), control unit 2 accepts the instruction signal applied from operation switch unit 7 based on the operation contents, and thus enables the switch operation (step S4). Accordingly, even when the user carelessly touches the switch of operation switch unit 7 during the charging of main battery 10, it is possible to prevent a malfunction of mobile work robot 1 due to such switch operation, and damage or the like of mobile work robot 1 due to a malfunction can be avoided.

Control unit 2 turns on the respective LEDs of LED unit 6 in a random fashion (step S7), and thereby notifies the user that main battery 10 is being charged.

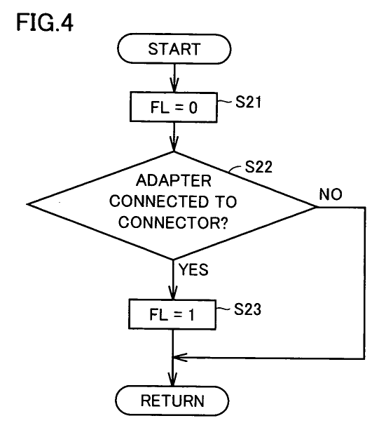

Referring to FIG. 4, description will now be given on an example of processing procedure for detecting the charging state in step S2. First, CPU 23 sets flag FL to “0” (step S21).

Then, it is determined whether AC adapter 12 is connected to power supply connector 11 (step S22). When AC adapter 12 is connected to power supply connector 11, main battery 10 enters the charging state, i.e., the state for charging battery 10. When AC adapter 12 is connected to power supply connector 11, power supply connector 11 provides a signal, which indicates the connection of AC adapter 12, to control unit 2. CPU 23 receives the signal indicating the connection of AC adapter 12 from power supply connector 11, and detects the connection according to the received signal (YES in step S22). From the detection of the connection, CPU 23 detects that main battery 10 is in the charging state, and sets flag FL to “1” (step S23).

In step S2, the “charging state” of main battery 10 is detected and, according to FIG. 4, this detection is performed by detecting the connection between the body of mobile work robot 1 and the charging unit (AC adapter 12 in this example) based on the signal provided from power supply connector 11. However, another manner may be employed.

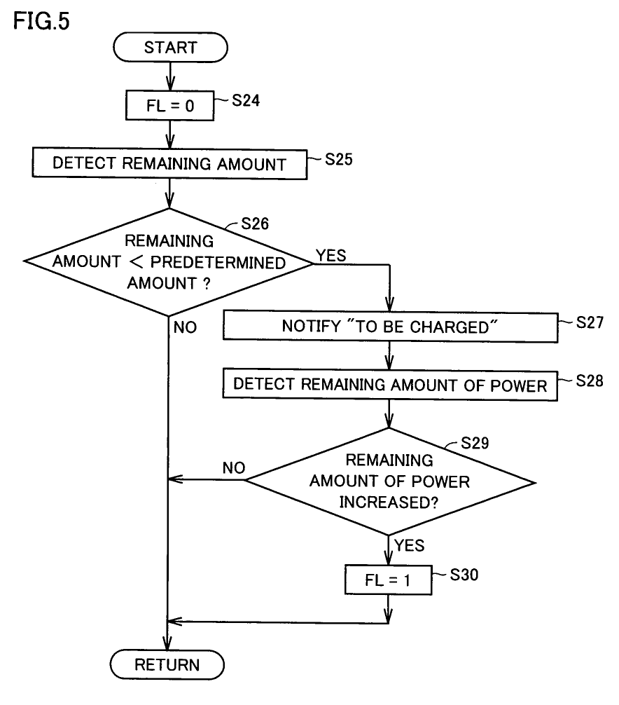

For example, a manner in FIG. 5 may be used instead of the manner in FIG. 4. A procedure in FIG. 5 utilizes a remaining amount detecting unit 2A, which detects a remaining amount (in the unit mAH) of power of main battery 10. Referring to FIG. 5, CPU 23 sets flag FL to “0” (step S24). The remaining amount of power of main battery 10 is detected by remaining amount detecting unit 2A (step S25). When a result of detection of remaining amount detecting unit 2A indicates that the remaining amount of power of main battery 10 is lower than a predetermined value requiring the charging (YES in step S26), CPU 23 notifies by LED unit 6 that the charging of main battery 10 is necessary (step S27). In accordance with this notification, the user connects AC adapter 12 to power supply connector 11 to start the charging of main battery 10. Remaining amount detecting unit 2A detects the currently remaining amount of main battery 10 (step S28). The currently detected remaining amount of main battery 10 is compared with the last-detected remaining amount (step S29). Based on the result of comparison, it is determined the remaining amount is increasing (YES in step S29) because the charging is being performed. Therefore, CPU 23 determines that the charging is being performed, and sets flag FL to “1” (step S30).

When the remaining amount of power of main battery 10 is not lower than the predetermined value (NO in step S26), the charging is not necessary so that the processing in FIG. 5 ends without changing flag FL from “0”. When it is not detected that the remaining amount is not increasing (NO in step S29), main battery 10 is not in the charging state so that the processing in FIG. 5 ends without changing flag FL from “0”.

According to the procedure in FIG. 5, CPU 23 determines that the battery is currently in the charging state when the remaining amount of main battery 10 increases above the predetermined value after detecting that the remaining amount of main battery 10 is lower than the predetermined value.

Although the present invention has been described and illustrated in detail, it is clearly understood that the same is by way of illustration and example only and is not to be taken by way of limitation, the spirit and scope of the present invention being limited only by the terms of the appended claims.

1. A mobile work robot comprising:
a running unit for movement;
a working unit;
a control unit accepting a instruction signal and controlling various portions of said mobile work robot with the accepted instruction signal;
an operation unit externally operated to provide said instruction signal for controlling an operation of said mobile work robot to said control unit; and
a battery supplying an electric power to the various portions of said mobile work robot, wherein
said control unit does not accept said instruction signal while said battery is in a charging state.

2. The mobile work robot according to claim 1, wherein
said control unit includes state determining means for determining whether said battery is in said charging state or not.

3. The mobile work robot according to claim 2, further comprising:
charge detecting means for detecting a connection of said battery to a charging unit prepared in advance, and outputting a detection signal, and
said state determining means determines whether said charging state is currently achieved or not, based on said detection signal received from said charge detecting means.

4. The mobile work robot according to claim 3, further comprising:
means for notifying that said charging state is currently achieved.

5. The mobile work robot according to claim 2, wherein
said state determining means determines whether said charging state is currently achieved or not, based on a remaining amount of power of said battery.

6. The mobile work robot according to claim 5, further comprising:
means for notifying that said charging state is currently achieved.

7. The mobile work robot according to claim 2, further comprising:
means for notifying that said charging state is currently achieved.

8. The mobile work robot according to claim 1, further comprising:
means for notifying that said charging state is currently achieved.
